(19) United States
(12) Patent Application Publication
(10) Pub. No.: US 2007/0124279 A1
(43) Pub. Date: May 31, 2007

(54) Method for quickly retrieving a record in a data page of a database

(75) Inventors: Shiliang Li, Guangdong Province (CN); Hong Gao, Guangdong Province (CN); Ling Hong, Guangdong Province (CN)

Correspondence Address: WELSH & KATZ, LTD, 120 S RIVERSIDE PLAZA, 22ND FLOOR, CHICAGO, IL, 60606, US

(73) Assignee: ZTE Corporation, Shenzhen City, Guangdong (CN)

(21) Appl. No.: 10/584,010

(22) PCT Filed: Jun. 22, 2004
(86) PCT No.: PCT/CN04/00668

§ 371 Date: Jun. 21, 2006

(30) Foreign Application Priority Data
Dec. 31, 2003 (CN) 200310124201.4

(51) Int. Cl. G06F 17/30

(52) U.S. Cl. 707/3

(57) ABSTRACT

The present invention relates to a method for fast locating records on a data page in a database, comprising the steps of: setting a directory structure composed of a group of record deviations at the end of a data page, in which, a record deviation is a position deviation of a record on the data page; each directory in the directory structure is called dir_slot, and each dir_slot stores the position deviation of one record; searching for relative records in the dir_slot by adopting a dichotomizing locating algorithm, after locating one certain dir_slot, searching the relative group of records in order according to the record deviation stored in the dir_slot and locating the record to be searched for accurately. The present invention greatly improves the speed of locating a record on a page, saves large amount of costs for sequential search, largely reduces times of searching and comparing, and manages the records on the pages effectively.

### TECHNICAL FIELDS

The present invention relates to a method for managing records on a data page in a database, particularly relates to a method for fast locating records on a data page in a database.

### TECHNICAL BACKGROUND

Database system is a very effective software system for managing a large amount of data. The least unit to be managed in a database is record, each of which memorizes a group of relative information. Data page is a physical unit for storing record, each of which can store multiple records. Every record on data page has an index, which refers to a next record, thereby all the records on the whole page link one by one to form a linearity record chain; when searching a certain record, it can be located by searching along the linearity record chain. However, this kind of method has a disadvantage that the search efficiency on a page is quite low, which leads to a low efficiency of database search.

### SUMMARY OF THE PRESENT INVENTION

The object of the present invention is to provide a method for fast locating records on a data page in a database, thereby enhancing the speed of locating data record in database.

The records on a data page are stored in sequence, and the scheme employed in the present invention is as follows: at the end of a data page, setting a directory structure which is composed of a group of record deviations—the position deviations of records in the data page; each directory in the directory structure is called dir_slot, each of which stores position deviation of a record; according to the position deviation, a certain record can be located immediately. But not the position deviation of all records is stored in the dir_slot, in the linearity record chain of the data page, the deviation of one record is selected to be stored in dir_slot every certain number of records (this number of records is between the maximum records number and minimum records number in the dir_slot). Thus, each page has a directory structure, when searching, it is to search the relative record in dir_slot by adopting a fast dichotomizing locating algorithm rather than search the specific record, after locating a certain dir_slot, searching the relative group of records according to the record deviation stored in the dir_slot, as such the record to be searched can be located accurately.

Specially, the present invention discloses a method for fast locating records on a data page in database, comprising the following steps of:

(1) setting a directory structure at the end of a data page, which is composed of a group of record deviations, a record deviation is a position deviation of a record in the data page; each directory in the directory structure is called dir_slot, and each dir_slot stores position deviation of one record;

(2) searching for relative records in the dir_slot by adopting a fast dichotomizing locating algorithm, searching for a relative group of records according to the record deviations stored in the dir_slot after locating one certain dir_slot, and locating the record to be searched for accurately.

Said method for fast locating record on a data page in database further includes: putting the record to be searched into a field structure, and comparing the record on the data page with the field structure.

Said method for fast locating record on a data page in database comprises the steps of: first endowing two variables (low, up) which represent the number of dir_slot with initial value, low is endowed with a value of 0, up is endowed with a value that is the total number of dir_slot on a page, then searching by adopting locating algorithm, and judging which dir_slot the record belongs to.

Said locating algorithm is dichotomizing locating algorithm.

Said dichotomizing locating is to compare medial value with field structure continuously, until the value of up-low is not more than 1.

After finding the record, select record orderly from the dir_slot with the number of low to compare with the field structure, till the next record of the record is the up record up_rec on the dir_slot with the number of up; if the record is found during this process, finishing the search on this page; if the record is not found, turning to the next page to perform the same match.

Said method for fast locating record on a data page in database, when the number of record on dir_slot is full due to the addition of one record onto a data page in database, splitting the current dir_slot into two ones, so as to increase one dir_slot.

After the record inserting into a chain table, if the total number of records on the dir_slot where the record locates exceeds a maximum value, moving all of the dir_slots behind this dir_slot one bit backward, thus, one dir_slot is added, and dividing all records on the dir_slot which this record belongs to into two parts, and attaching these two parts to the two dir_slots respectively.

Said method for fast locating record on a data page in database, wherein when deleting a record, taking it out from the chain table and sets a deleting mark to it.

First, obtaining a dir_slot next to this dir_slot, and judging the record number on the next dir_slot, if the record number exceeds the minimum value, taking out a record from the next dir_slot, and adding it to the current dir_slot; if the record number is less than or equal to the minimum value, combining these two dir_slots, and deleting the current dir_slot.

### BRIEF DESCRIPTION OF DRAWINGS

FIG. 1 is the structure description of data page according to the present invention;

FIG. 2 is the flowchart for adding dir_slot according to the present invention;

FIG. 3 is the flowchart for deleting dir_slot according to the present invention;

FIG. 4 is the flowchart for locating record in data page according to the present invention.

### PREFERRED EMBODIMENT OF THE PRESENT INVENTION

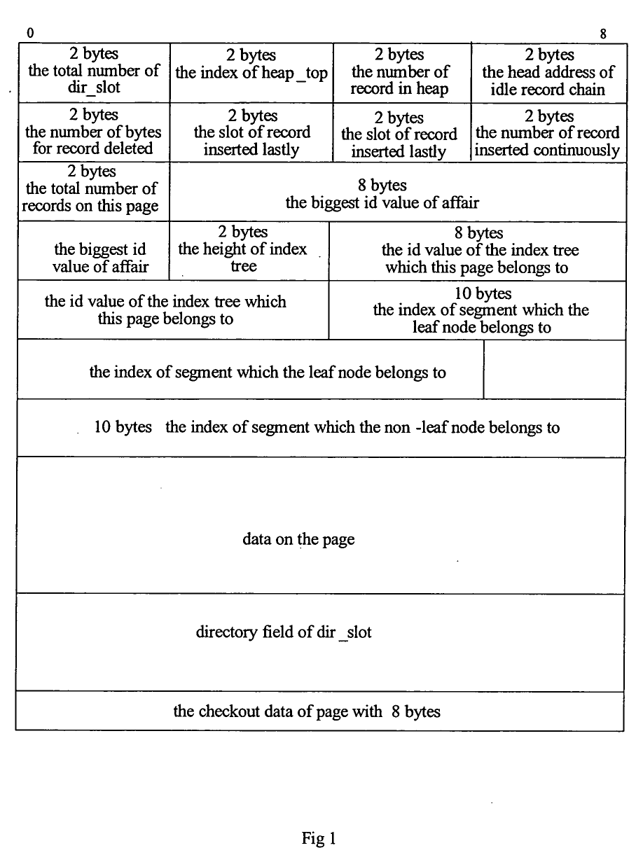

FIG. 1 is an integral structure diagram of data page, which describes the complete structure of a data page. In this drawing, the front 26 bytes describes the attribute of records in this page, the bytes from 26 to 36 describes the attribute of this page, the bytes from 36 to 56 is the segment index, dir_slot extends from the end of this page; by employing this scheme, it avoids the requirement of presetting space for dir_slot. Thus, when adding or deleting records, it is not necessary to consider how many records have been stored and how many dir_slots have been used.

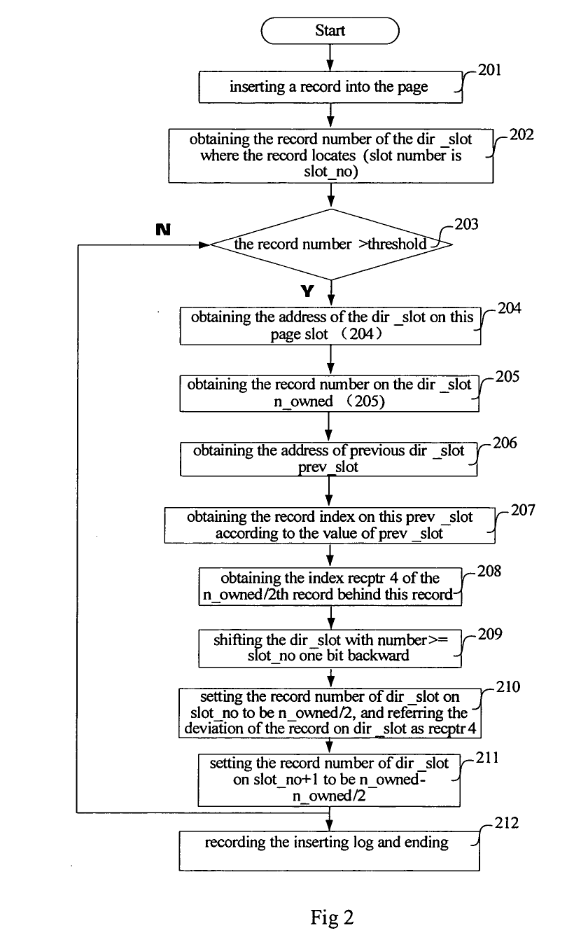

FIG. 2 is the flowchart for adding dir_slot, which describes that when inserting records into a data page in database, how dir_slot splits the current dir_slot into two ones in order to add dir_slot when the record number on the dir_slot where the record locates has reached the maximum value. The records on each page form a record chain table, the record to be inserted will be inserted into a relative position in the chain table, generally in an ascending order. As shown in FIG. 2, after inserting the record into the chain table (step 201), first obtaining the record number (the number of slot is slot_no) on the dir_slot where this record locates (step 202), then judging whether the record number on the dir_slot where the record locates exceeds the maximum value (step 203), if not, recording the inserting log directly, and ending (step 212); if yes, obtaining the address slot of this dir_slot on this page (step 204), obtaining the record number n_owned on this dir_slot (step 205), obtaining the address prev_slot of the previous dir_slot (step 206), obtaining the record index on the prev_slot according to the value of prev_slot (step 207), obtaining the index recptr 4 of the prev_slot/2th record next to this record (step 208), moving the dir_slot which is more than or equal to slot_no one bit back (step 209), thus, a dir_slot is added, and dividing all the records on the dir_slot where this record loates into two parts, that is, setting the record number of dir_slot on slot_no to be n_owned/2, and referring the record deviation on dir_slot as recptr4 (step 210), setting the record number of dir_slot on slot_no+1 to be n_owned-n_owned/2 (step 211), thus, attaching these two parts of records to these two dir_slots respectively, then recording the inserting log, and ending (step 212).

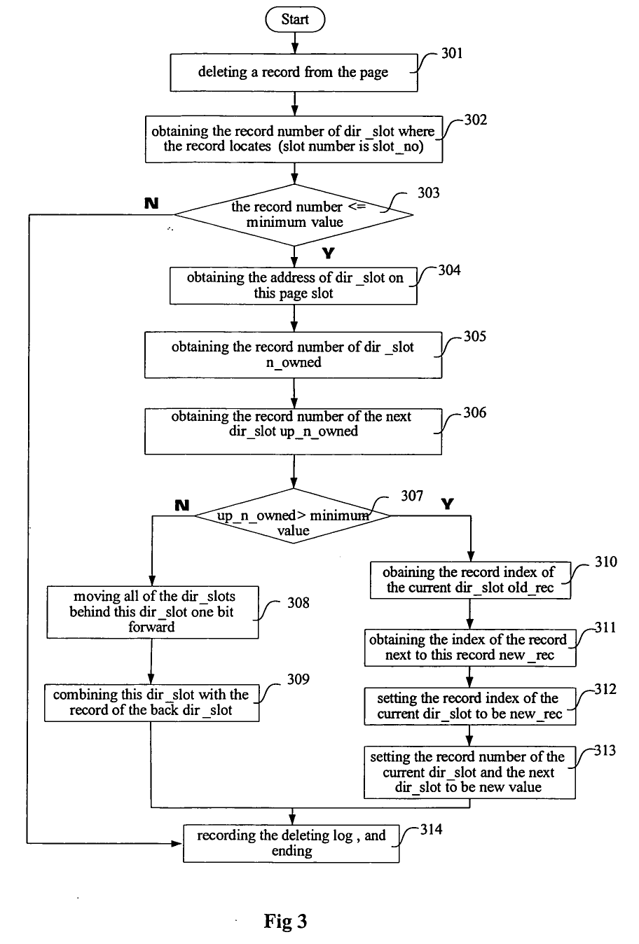

FIG. 3 is the flowchart for deleting dir_slot, which describes that when deleting record, how to combine two dir_slots if the record number on dir_slot is less than the minimum value, and when deleting a record on a data page in database, how the system adjusts the dir_slot. The records on each page form a record chain table, when deleting a record, taking the record out from the chain table, and setting a mark of deleting onto it (step 301), obtaining the total record number of the dir_slot where this record locates (step 302), if the total record number is less than or equal to the minimum value (step 303), adjusting the dir_slot: first obtaining a dir_slot next to this dir_slot (steps 304-306), and judging the record number of the next dir_slot (step 307), if the record number is more than the minimum value, taking out one record from the next dir_slot, and adding it to the current dir_slot, specifically, taking out the record index old_rec of the current dir_slot (step 310), taking out the next record index new_rec of this record (step 311), setting the record index of the current dir_slot to be new_rec (step 312), setting the record of the current dir_slot and the record of the next dir_slot to be new value (step 313), then recording the deleting log, and ending (step 314); if the record number is less than or equal to the minimum value, moving all of the dir_slots behind this dir_slot one bit forward (step 308), combining this dir_slot with the next dir_slot (step 309), recording the deleting log, and ending (step 314). Thus, the adjustment of dir_slot is completed.

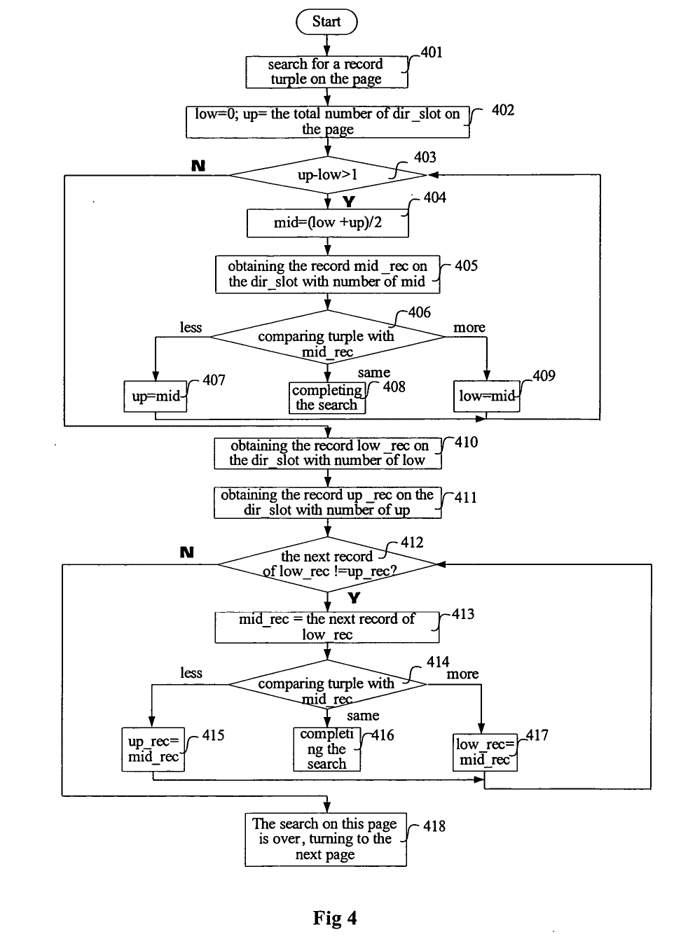

FIG. 4 is the flowchart for locating records in data page, which describes the flowchart of how to locate a record on a data page and how to search for a record on a data page. The value of part of domain of record to be searched is put into the field structure turple (step 401), (the called field structure turple is a structure composed of part of field of record to be searched. In order to search for a record in database, it is necessary to get part of content of the record, for example, in a personnel archives database, one can search through the name field, and the name field forms a turple), and the record on data page will be compared with the field structure, comprising the following steps of: endowing two variables low and up which represent the number of dir_slot with initial value, low is endowed with value 0, up is endowed with a value which represents the total number of dir_slot on page (step 402), then searching via dichotomizing algorithm, and judging which dir_slot the record belongs to; the method of searching via dichotomizing algorithm is to take out mediate value continuously to compare with the field structure, till the value of up-low is not more than 1; specifically, said dichotomy is to take the mediate value of dir_slot on page to compare with turple; setting mid=(low+up)/2, hereby obtaining the record mid_rec with number of mid on dir_slot, and comparing the mid_rec with the field structure, if mid_rec is more than turple, making up=mid, if mic_rec is less than turple, making low=mid, and comparing again (step 403, 404, 405, 406, 407, 409); after finding the record, taking out records from dir_slot with number low in order to compare with the field structure, till the next record of this record is up_rec (up_=1 rec is the head record of dir_slot with number up) (step 410, 411, 412, 413, 414, 415, 417); if the record is found during the process, ending the search on this page (step 408 and step 416); if no record is found, turning to the next page to perform the same match (step 418). In the above process, by employing the dir_slot structure, the relative record can be located quickly on the page.

For example, supposing that 300 records are stored on one page, if locating in order, it needs to match for 300 times. While by employing the method of the present invention, about 40 dir_slots are needed to store the deviation of part of the records, by employing dichotomizing locating algorithm, it only needs to match 5 times at best to locate the specific dir_slot, 8 times at best to locate in dir_slot, and 13 times to locate in the worst situation, thereby the search speed on the page is improved 23 times. Because dir_slot is put at the end of the page, it is not necessary to preset space on the page, and the records on the page are managed efficiently. Because dir_slot only stores the deviation of one record, the space occupied is very little, supposing that each deviation is 4 bytes, 300 records need a storage space of about 160 bytes in all.

### INDUSTRIAL APPLICABILITY

The advantage of the present invention compared to prior art is in that: the speed for locating a record on a page is improved greatly. When searching for a record, it only needs to fast locate and search in dir_slot in directory structure rather than search and compare in the order of record chain, thus, the large overhead for sequential search is saved, and after locating the specific dir_slot, the largest number of searching and comparing times is the maximum value of records of dir_slot. By employing this method, the times for seaching and comparing is greatly reduced. Because the dir_slot is put at the end of the page, it is not necessary to preset space on the page, and the records on the page are managed efficiently. Because dir_slot only stores the deviation of one record, the space occupied is very little.

1. A method for fast locating records on a data page in a database, comprising the steps of:
(1) setting a directory structure composed of a group of record deviations at the end of a data page, in which, a record deviation is a position deviation of a record on the data page; each directory in the directory structure is called dir_slot, and each dir_slot stores the position deviation of one record; and
(2) searching for relative records in the dir_slot by adopting a locating algorithm, after locating one certain dir_slot, searching the relative group of records in order according to the record deviation stored in the dir_slot and locating the record to be searched for accurately.

2. The method for fast locating record on a data page in a database of claim 1, further comprising the following steps of:
putting the record to be searched for into a field structure, and comparing the record on the data page with the field structure.

3. The method for fast locating record on a data page in a database of claim 2, which is characterized in:
first endowing two variables low and up which represent the number of dir_slot with initial values, in which, low is endowed with a value of 0, up is endowed with a value that is a total number of dir_slot on the page, then searching by adopting locating algorithm, and judging which dir_slot the record belongs to.

4. The method for fast locating record on a data page in a database of claim 1, in which, said locating algorithm is dichotomizing locating algorithm.

5. The method for fast locating record on a data page in a database of claim 4, in which, said dichotomizing algorithm is to take out a medial value continuously to compare with the field structure, until the value of up-low is not more than 1.

6. The method for fast locating record on a data page in a database of claim 3, which is characterized in:
after finding the record, selecting records orderly from dir_slot with the number of low to compare with the field structure, till the record next to this record is a up record up_rec of the dir_slot with the number of up; if the record is found during this process, finishing the search on this page; if the record is not found, turning to the next page to perform the same match.

7. The method for fast locating record on a data page in a database of claim 1, which is characterized in:
when the record number of dir_slot is full due to inserting of one record onto a data page in a database, splitting the current dir_slot into two ones, so as to increase a dir_slot.

8. The method for fast locating record on a data page in a database of claim 7, which is characterized in:
if the total number of records on the dir_slot where the record locates exceeds a maximum value after inserting the record into a chain table, moving all of the dir_slots behind this dir_slot one bit backward, thus, increasing one dir_slot, and dividing all the records on the dir_slot where this record belongs to into two parts, and attaching these two parts of records to the two dir_slots respectively.

9. The method for fast locating record on a data page in a database of claim 1, which is characterized in:
when deleting a record, taking it out from a chain table and setting a deleting mark to it.

10. The method for fast locating record on a data page in a database of claim 9, which is characterized in:
obtaining a dir_slot next to this dir_slot first, and judging the record number of the next dir_slot, if the record number exceeds a minimum value, taking out a record from the next dir_slot, and adding it to the current dir_slot; if the record number is less than or equal to the minimum value, combining these two dir_slots, and deleting the current dir_slot.
